(19) United States
(12) Patent Application Publication
(10) Pub. No.: US 2025/0036695 A1
(43) Pub. Date: Jan. 30, 2025

(54) GENERATING ENHANCED OUTPUT OF GENERATIVE MODELS USING INTENT-SPECIFIC GROUNDING

(71) Applicant: Microsoft Technology Licensing, LLC, Redmond, WA (US)

(72) Inventors: Marcelo Medeiros DE BARROS, Redmond, WA (US); Arun Kumar SACHETI, Sammamish, WA (US); Chunduri Bhanu Teja, Bothell, WA (US); Parthasarathy GOVINDARAJEN, Sammamish, WA (US); Kalpesh BHIMANI, Bothell, WA (US); Manish MITTAL, Woodinville, WA (US); Shama BILDIKAR, Sammamish, WA (US)

(21) Appl. No.: 18/361,875

(22) Filed: Jul. 30, 2023

(51) Int. Cl. G06F 16/9535; G06F 9/451; G06F 16/9538; G06N 5/022

(52) U.S. Cl. CPC G06F 16/9535; G06F 9/451; G06F 16/9538; G06N 5/022

(57) ABSTRACT

A computing system for generating enhanced output of a generative model is disclosed. The computing system is configured to receive an input set forth by a user of a client computing device that is in network communication with the computing system. An intent classifier produces, from the input, an output indicative of a user intent. The output of the intent classifier and the input are provided as input into a workflow model. The workflow model generates a prompt based upon the input and the user intent and provides the prompt as input into a generative model, which causes the generative model to generate an output based upon the prompt. The workflow model receives the output of the generative model and identifies supplemental content related to the output. The workflow model then generates an enhanced output based upon the output and the supplemental content for presentation to the user.

### BACKGROUND

A conventional online search experience generally involves a computer-implemented search engine configured to receive a query from a user operating a client computing device in network communication with the search engine, wherein, responsive to the receiving the query, the search engine identifies results that are relevant to the query. The search engine can then provide those results to the client computing device for presentation to the user. If the results are not responsive to the query, the results provided by the search engine may be refined through additional and/or altered input from the user operating the client computing device. Each revision or update to the input requires the search engine to execute a separate search which can consume excess computational resources and is dependent on the quality of input provided by the user.

This process is further complicated for intentionally open-ended queries where the query is focused on a general category or characteristic of something. A query input of “what is a good birthday gift for my wife” received by the search engine may result in the search engine identifying articles or other content related to gifts for a spouse. However, the articles or other content must be individually accessed and understood by the user and further, may require input of additional information to refine the query until the results returned by the search engine are relevant or interesting to the user. As each result is inspected by the user, if the query is to be refined, the user is required to navigate back to the search engine results page to further refine the query and re-execute the search. The back-and-forth process required to induce more relevant results to be returned by the search engine is an impersonal and static process that may steer a user away from using the search engine for a similar purpose again.

Relatively recently, generative models, including generative language models (GLMs) (also referred to as large language models (LLMs)) have been developed to generate content through an interactive user experience. These generative models are configured to generate an output (such as text in human language, source code, music, video, and the like) based upon input set forth by a user and in near real-time (e.g., within a few seconds of receiving the input). The generative model then generates content based upon training data over which the generative model has been trained. This means that generative models can generate output regarding information that may be represented by many different sources within its training data, while being deficient with respect to generating output responsive to intent-specific queries that are not well represented within the training data set. Moreover, because conventional generative models rely on the data from which they were trained, they are generally not well-suited to generate responses with respect to input that is based in time, particularly recent time. As with the example query set forth above, “what are some birthday gifts for my wife,” a conventional generative model may only give suggestions of gifts that were released at the time the generative model was trained, which can result in undesirably stale output.

### SUMMARY

The following is a brief summary of subject matter that is described in greater detail herein. This summary is not intended to be limiting as to the scope of the claims.

Various technologies are described herein that relate to providing enhanced output of a generative model by generating intent-specific information to be provided to the generative model as input and enhancing the responsive output of the generative model with supplemental information based upon an intent. Information that is used by the generative model to generate output is referred to as a prompt. In accordance with technologies described herein, a workflow model comprises an intent classifier, wherein the intent classifier is configured to generate an output indicative of user intent from information provided by a user. From the intent classifier output, the workflow model can generate a prompt to provide as input into a generative model. The prompt generated by the workflow model is based upon the information provided as input from the user and the output of the intent classifier. The workflow model then provides the prompt as input into the generative model and causes the generative model to produce an output based upon the prompt. The output of the generative model is then passed to the workflow model where the workflow model is configured to identify supplemental content related to the output. The workflow model can then generate an enhanced output based upon the output and the supplemental content and transmit the enhanced output to a client computing device for presentation to a user.

In an example, an input query set forth by a user is received at an entry point for interaction with a generative model, such as a webpage with a conversational “chatbot” or the like, where input received from a user may be indicative of a desire to interact with the generative model. A browser of a client computing device loads a webpage that is configured to receive the input (e.g., by way of text, voice, or the like) and the browser receives the input set forth by a user of the client computing device. The browser transmits the input to a computing system that executes an intent classifier. The intent classifier is configured to receive the input set forth by the user and produce an output indicative of an intent associated with the input. The intent is indicative of an objective related to the input, such as, for example, shopping. The intent may be further refined into a sub-intent.

Considering a shopping example, shopping may be representative of a global intent, however, this intent may be broken down into several sub-intents, for example, a category intent (e.g., the user is only interested in shopping for a certain category of goods or services), a product intent (e.g., the user is only interested in shopping for a specific product), a brand intent (e.g., the user is only interested in shopping for good or services offered by a specific brand), a merchant intent (e.g., the user is only interested in shopping for goods or services from a certain merchant), a buying guide intent (e.g., the user is interested in shopping for particular goods and services but wants to learn more about their attributes through one or more buying guides). It is appreciated that the exemplary intents and sub-intents are offered by way of example only and that the technologies described herein may be readily adaptable to accommodate many other intents and sub-intents.

Responsive to receiving the output of the intent classifier, a workflow model is triggered. In an example, the workflow model is a model (e.g., a generative model) trained using intent-specific data. For example, a shopping intent triggers a workflow model trained on a shopping corpus of data. The workflow model is configured to access certain data stores, such as, for example, a knowledge corpus containing data related to the subject intent associated with the workflow model (e.g., a shopping workflow model may have access to a shopping corpus containing product information, specification sheets, etc.). The workflow model may have access to a supplemental content data store comprising data related to the subject intent (e.g., a shopping workflow model may have access to a supplemental content data store comprising offers, advertisements, etc., related to the shopping intent). The workflow model also has access to a dialog history which is indicative of prior interaction between the user and the generative model.

Based upon the output of the intent classifier, the workflow model may cause graphical content to be displayed at a visual canvas at the client computing device. The graphical content is related to the intent associated with the output of the intent classifier, for example, if the output of the intent classifier was indicative of a shopping intent, certain graphical content associated with products may be displayed. (e.g., products on sale, trending products, products related to a user search history, etc.).

The workflow model generates a prompt based upon the input and the output of the intent classifier. The workflow model is further configured to query one or more data stores (e.g., the knowledge corpus, the supplemental content data store, the dialog history data store) and obtain, responsive to the query, data from the data stores to include in the prompt generated by the workflow model. The prompt generated by the workflow model is therefore representative of the original user-submitted input and the output of the intent classifier. The prompt is then provided to the generative model, wherein the generative model is configured to generate an output based on the prompt. Providing the prompt generated by the workflow model to the generative model improves over conventional generative models that are configured to receive input directly from a client computing device operated by a user.

Responsive to the generative model generating an output based upon the prompt, the output is transmitted to the workflow model for additional processing before presentation at the client computing device. At the workflow model, the workflow model can modify the output of the generative model with supplemental content, for example, generated by the workflow model and/or obtained from an intent-specific knowledge corpus and/or supplemental content data store. The supplemental content applied to the output may comprise additional text, graphical elements, or the like. The supplemental content may be related to suggested responses to the output that will further refine previous user input. For example, the resultant output from the generative model responsive to the input of “what are some birthday gifts for my wife” may comprise a list of gifts that the generative model compiled based on the prompt provided to the generative model. The workflow model may then parse the output of the generative model and obtain from one or more external data stores information related to each of the gifts identified by the generative model in the output. The workflow model may then generate further supplemental content adding additional contextual information and insight into the additional information obtained from the data stores. The supplemental content can be integrated into the output which is then transmitted to the client computing device for presentation to the user.

The process described above can be repeated each time a new input is received from the client computing device. Each additional input provides additional information that can be included by the workflow model in a prompt provided to the generative model. For example, if the workflow model receives an indication from the visual content canvas that a user has selected a certain element that was presented on the visual content canvas, aspects of the element can be added to a new/updated prompt to be provided to the generative model. As the generative model produces the output, the workflow model enhances the output and provides the enhanced output to the client computing device for presentation to the user.

The technologies described herein exhibit various advantages over conventional search engine and/or generative model technologies. Both conventional search engines and conventional generative models are deficient with respect to identifying and/or generating appropriate information in response to certain types of user input. The technologies described herein improve over conventional systems by generating improved prompts with intent specific grounding information and providing the improved prompts to the generative model. Additionally, the described technologies further improve over conventional systems by supplementing the output of the generative model before providing the output to a client computing device for presentation to a user. This reduces computational resources required to run the generative model by providing additional contextual information to the input before it is provided as a prompt to the generative model. Furthermore, the supplemental content applied to the output of the generative model may result in more specifically targeted subsequent input from the user which results in fewer iterations of the generative model needed to identify relevant information responsive to the initial input. Additionally, the generation of a conversational canvas and a visual canvas to be displayed at a client computing device further enhances capabilities related to interaction with the generative model and improves over conventional approaches which are generally limited to input-response interaction.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing system that facilitates interaction between a client computing device and a generative model.

FIG. 2 is a communications flow diagram that illustrates an example flow of communications between a client computing device, an intent classifier, a workflow model, and a generative model.

FIG. 3 is another functional block diagram of a computing system that facilitates interaction between a client computing device and a generative model.

FIG. 4 is another communications flow diagram that illustrates an example flow of communications between the client computing device, a conversational content canvas, a visual content canvas, a workflow model, and a generative model.

FIG. 5 depicts a graphical user interface (GUI) of a browser displaying a visual content canvas and a conversational content canvas by way of which communications are provided to and received from a workflow model and a generative model.

FIG. 6 is a flow diagram illustrating a methodology for providing enhanced output of a generative model.

FIG. 7 is a schematic of an exemplary computing system.

### DETAILED DESCRIPTION

Various technologies pertaining to providing enhanced output of a generative model are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, “model”, “engine”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

The technologies described herein are related to “grounding” a generative model or models with information that is usable by the generative model to generate output. In an example, grounding the generative model refers to providing the generative model with context that is usable by the generative model to generate output, where the context is in addition to user-generated input. With more specificity, a generative model generates output based upon a prompt. The prompt can include input generated by a user who is interacting with the generative model during a conversation (such as a query set forth by a user), previous inputs set forth by the user during the conversation, previous outputs generated by the generative model during the conversation, and previously defined instructions that describe how the generative model is to generate output. The technologies described herein relate to inclusion of additional information in the prompt, where such additional information can be obtained by a workflow model (e.g., based upon an output of an intent classifier associated with the workflow model; obtained from external data sources, such as a knowledge corpus, supplemental content data store, dialog history data store; etc.). In another example, the additional information can be obtained from a web browser (or other application) that has loaded a webpage being viewed by a user. In yet another example, the additional information can be obtained from a content canvas capable of receiving input from a user, such as, for example, a document, spreadsheet, presentation program, etc. The generative model generates output based upon this additional information in the prompt, which is passed to the workflow model wherein additional enhancement of the generative model output may occur. Each time additional input is received by the workflow model, additional grounding information may be applied to the input and added to the prompt provided to the generative model, further influencing the output provided by the generative model.

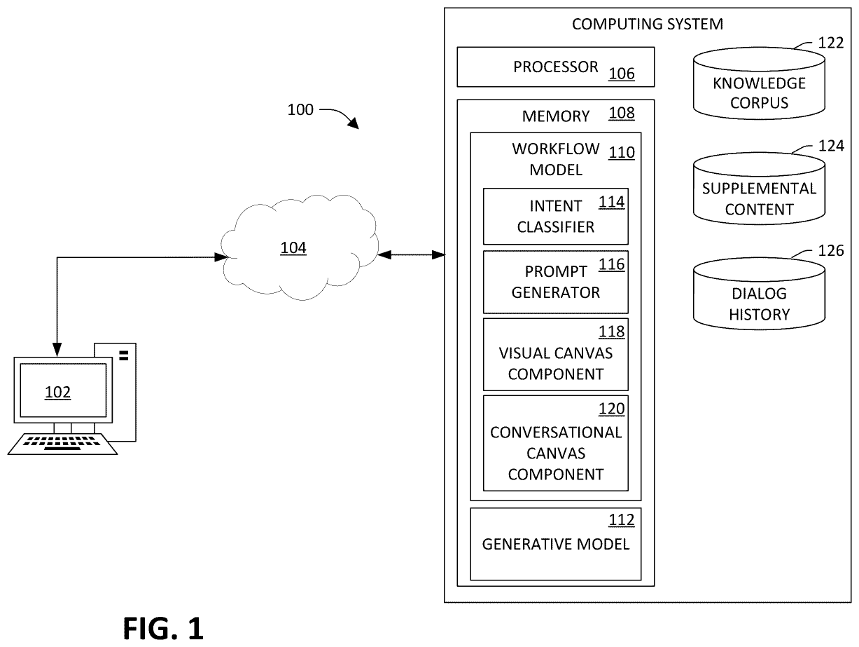

Referring now to FIG. 1, a functional block diagram of a computing system 100 is illustrated. While illustrated as a single system, it is to be understood that the computing system 100 may comprise several server computing devices, can be distributed across computing systems, data centers, etc. The computing system 100 is configured to obtain information based upon an input (e.g., query) set forth by a user and is further configured to provide the obtained information as a prompt (or portion thereof) to a generative model.

A client computing device 102 operated by a user is in communication with the computing system 100 by way of a network 104. The client computing device 102 can be any suitable type of client computing device, such as a desktop computer, a laptop computer, a tablet (slate) computing device, a video game system, a virtual reality or augmented reality computing system, a mobile telephone, a smart appliance, or other suitable computing device.

The computing system 100 includes a processor 106 and memory 108, where the memory 108 includes instructions that are executed by the processor 106. More specifically, the memory 108 includes a workflow model 110 and a generative model 112, where operations of the workflow model 110 and the generative model 112 are described in greater detail below. In an example, the generative model 112 is a generative language model (GLM), although it is to be understood that the generative model 112 can output images, video, etc. GLMs may also be referred to as large language models (LLMs). An example of a GLM is the Generative Pre-trained Transformer 4 (GPT-4). Another example of a GLM is the BigScience Language Open-science Open-access Multilingual (BLOOM) model. It is understood that computing system 100 may be readily adapted for use with any generative model beyond those offered by way of example herein. In certain embodiments, workflow model 110 is also a generative model, such as an LLM.

The computing system 106 also includes data stores 122-126, where the data stores 122-126 store data that is accessed by the workflow model 110 and/or the generative model 112. With more particularity, the data stores 122-126 include a knowledge corpus 122, a supplemental content data store 124, and a dialog history data store 126. While illustrated separately, it is appreciated that information as described as being associated with data stores 122-126 may be combined into a single data store and/or distributed amongst many different data stores. The information within data stores 122-126 may be accessed/obtained by the workflow model 110 via a query constructed by the workflow model.

The knowledge corpus 122 comprises information that may be used by the workflow model 110 to enhance inputs (e.g., via grounding information) for provided to the generative model 112. The knowledge corpus 122 may further be used by the workflow model 110 to enhance outputs received from the generative model 112. Certain aspects of the knowledge corpus 122 may correspond to a specific user intent. For example, a shopping corpus corresponds to a shopping or commercial intent and may comprise information relating to certain products, brands, merchants, buying guides, etc. For example, a shopping corpus may comprise one or more shopping catalogues which comprise a large data set of products and information about those products. The knowledge corpus 122 may comprise both static and dynamic data. For example, a shopping corpus may comprise pricing data which is frequently updated with current pricing information, while also comprising product reviews, which are generally not updated and reflect an individual's assessment of a product or service at a particular point in time. The knowledge corpus 122 may be used by the workflow model 110 to obtain grounding information to be applied the prompts generated by the workflow model 110 for providing the prompts to generative model 112.

The supplemental content data store 124 includes supplemental content, such as images, videos, advertisements, offers, or the like. The supplemental content data store may further comprise graphical elements which can be applied to the output generated by the generative model 112 and/or transmitted to the client computing device for presentation to a user.

The dialog history data store 126 includes dialog history, where the dialog history includes dialog information with respect to users and the generative model 112. For instance, the dialog history can include, for a user, identities of conversations undertaken between the user and the generative model 112, input provided to the generative model 112 by the user for multiple dialog turns during the conversation, dialog turns in the conversation generated by the generative model 112 in response to the inputs from the user, queries generated by the generative model 112 during the conversation that are used by the generative model 112 to generate responses, and so forth. In addition, the dialog history can include context obtained by the workflow model 110; for instance, with respect to a conversation, the dialog history 122 can include content from results identified based upon queries set forth by the user and/or the generative model 112 during the conversation, content from information identified by the workflow model 110 based upon queries set forth by the user and/or the generative model 112 during the conversation, and so forth.

The data stores 114-122 are presented to show a representative sample of types of data that are accessible to the workflow model 110 and/or the generative model 112; it is to be understood that there are many other sources of data that are accessible to the workflow model 110 and/or the generative model 112, such as data stores that include real-time finance information, data stores that include real-time weather information, data stores that include real-time sports information, data stores that include images, data stores that include videos, data stores that include maps, etc. Such sources of information are available to the workflow model 110 and/or the generative model 112.

The workflow model 110 comprises an intent classifier 114, prompt generator 116, visual canvas component 118, and a conversational canvas component 120. While described as separate components, it is appreciated that each operation performed by the intent classifier 114, prompt generator 116, visual canvas component 118, and conversational canvas component 120, may also be described as being performed by workflow model 110. The intent classifier 114 receives the input set forth by the user at the client computing device 102. From the input, the intent classifier 114 is configured to produce an output indicative of an intent associated with the input. The intent classifier 114 may be a classification model trained on intent-specific information such that output of the intent classifier 114 is indicative of an intent associated with the input (e.g., “what is a good birthday gift for my wife” may be classified as a commercial or “shopping” intent). The intent is indicative of an objective related to the input, such as, for example, shopping. The intent may be further refined into a sub-intent.

Considering the shopping example used above, shopping may be representative of a global intent, however, an intent may be broken down into several sub-intents, for example, a category intent (e.g., the user is only interested in shopping for a certain category of goods or services), a product intent (e.g., the user is only interested in shopping for specific product), a brand intent (e.g., the user is only interested in shopping for good or services offered by a specific brand), a merchant intent (e.g., the user is only interested in shopping for goods or services from a certain merchant), a buying guide intent (e.g., the user is interested in shopping for particular goods and services but wants to learn more about their attributes through one or more buying guides). It is appreciated that the exemplary intents and sub-intents are offered by way of example only and that the technologies described herein may be readily adaptable to accommodate many other intents and sub-intents. The intent classifier 114 provides its output indicative of a user intent to the workflow model 110 which can then use the output to generate a more accurate and effective prompt for input into the generative model 112.

Workflow model 110 further comprises a prompt generator 116. The prompt generator 116 is configured to generate a prompt for input into the generative model 112 which causes the generative model 112 to produce an output. Responsive to receiving an indication of an intent associated with the input (e.g., from the output of the intent classifier 114), the workflow model 110 may obtain grounding information from knowledge corpus 122 (and/or other external data sources) wherein the grounding information is associated with the intent. The grounding information may then be added to the prompt generated by the prompt generator 116. In an example, the prompt generated by prompt generator 116 may be grounded according to different personas (e.g., beginners, intermediate, advanced, etc.) The prompt generator 116 may generate a prompt based on prior prompts. For example, if a prior prompt was indicative of a shopping intent, for running shoes, for an advance runner, each subsequent prompt generated by the prompt generator 116 may include the prior prompt information in the subsequently generated prompt. Each prompt may comprise implicit or explicit grounding data. For example, implicit grounding data may be information obtained from one or more data sources (e.g., knowledge corpus 122). The implicit grounding data may be further based on a specific intent, for example, upon recognition of a shopping intent, the prompt generator 116 may apply implicit grounding information related to shopping and assistance related to shopping. Grounding data applied by prompt generator 116 may also be explicit. Explicit grounding data may be keywords or other aspects identified explicitly from user input. Another example of explicit grounding data may correspond to a specific user action, such as clicking on a link or expanding a list (e.g., within a visual canvas).

The workflow model 110 further comprises a visual canvas component 118 and a conversational canvas component 120. The visual canvas component 118 is configured to cause graphical elements to be displayed at the client computing device 102. The graphical elements may be based on information related to the user (e.g., based upon prior interaction with the generative model 112, prior search engine history, etc.). The graphical elements may also be related to popular or trending content based upon interactions with workflow model 110 and/or generative model 112. The visual canvas component 118 may receive signals from a corresponding visual canvas at the client computing device 102. Responsive to said signals, the visual canvas component 118 may cause data received from the visual canvas at the client computing device to be included by the workflow model 110 in a prompt. For example, if an input is received from the client computing device 102 is indicative of a certain user action with regard to a graphical element on the visual canvas (e.g., button click, expansion of a list of items, “tell me more” button, etc.) data based upon that interaction at the visual canvas is caused to be included in a prompt generated by the workflow model 110. Responsive to certain data received from the visual canvas, the visual canvas component 118 may cause different (i.e., new/updated/revised content) visual content to be displayed at a corresponding visual canvas at the client computing device.

Not all user action at the visual canvas will generate a signal that causes the data related to the signal to be added to a prompt by the workflow model 110. For instance, certain actions may be related to merely browsing content, and not amount to a manifest intent from the user to update a prompt and generate new output by the generative model 112. These actions may cause a signal to be received by the visual canvas component 118, but only certain signals will trigger action by the workflow model 110. Absent receiving an instructive signal at the visual canvas component 118, the workflow model 110 will not include data from the visual canvas in a prompt. This enables the visual canvas and the conversational canvas to operate independently, yet remain synchronized upon receipt of certain signals.

The conversational canvas component 120 is configured to receive input from a conversational canvas on the client computing device 102. The conversational canvas component 120 may also cause textual and/or graphical elements to be displayed at a conversational canvas associated with the client computing device. The enhanced output as generated by the workflow model 110 is passed by the conversational canvas component 120 to a conversational canvas at the client computing device 102. Graphical elements, such as, for example, user selectable suggested element “pills” can be generated by the conversational canvas component for display at the conversational canvas at the client computing device 102. When the conversational canvas component 120 receives input from the conversational canvas at the client computing device 102 (e.g., selection of graphical content “suggestions”, user typing, etc.) the workflow model 110 may include the input into a prompt to be generated and provided to the generative model 112.

As discussed above, operation of the workflow model 110 is improved through use of the generative model 112, and operation of the generative model 112 is improved through use of the workflow model 110. For instance, the workflow model 110 is able to present to a user enhanced outputs that the generative model 112 was not previously able to provide (e.g., based upon enhanced input provided to the generative model 112 and/or enhancement of the output of the generative model 112), and the generative model 112 is improved by using information obtained by the workflow model 110 to generate outputs (e.g., information identified by the workflow model 110 included in the prompt generated by the workflow model 110 and used by the generative model 112 to generate outputs). Specifically, the generative model 112 generates outputs based upon information obtained by the workflow model 110, and accordingly, the outputs have a higher likelihood of responsiveness and relevancy to the input (e.g., by corresponding to an intent of the user) when compared to outputs generated by generative models that are not based upon such information, as the prompt generated by workflow model 110 is grounded using data relating to the intent (e.g., based upon the output of the intent classifier which is indicative of an intent of the user input).

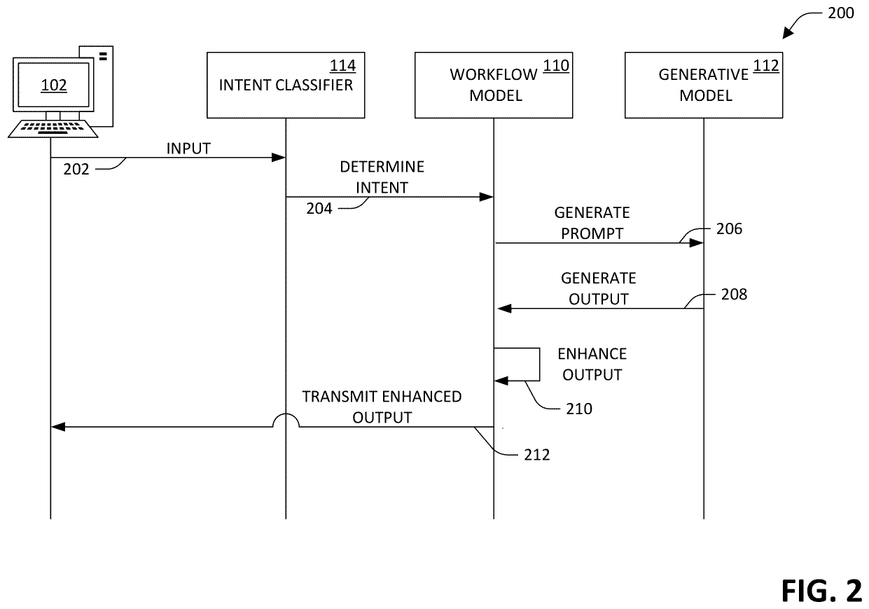

Examples of operation of the computing system 100 are now set forth. It is to be understood that these examples are non-limiting, and that permutations of such examples are contemplated. Referring to FIG. 2, a communications diagram 200 depicting communications between the client computing device 102, the workflow model 110, and the generative model 112 in accordance with a first example is presented. The client computing device 102 is executing an application such as a web browser, and the application receives a query (user input) that is to be transmitted to the workflow model 110 executing at the computing system 100. For instance, the web browser can load a homepage related to the generative model 112 and the web browser receives a query from a user in a text entry field (e.g., a conversational canvas). In an example, the text entry field is a “chat bot” or the like, wherein the “chat bot” may be displayed as an overlay of visual content displayed at a client computing device. Interaction with the “chat bot” may comprise input that is indicative of a user intent to interact with the generative model 112 which can initialize the process illustrated in the communications diagram 200.

At 202, the client computing device 102 transmits the input (i.e., query) to the intent classifier 114. It is appreciated that while the intent classifier 114 is depicted separately, the intent classifier may be embodied as part of the workflow model 110. In other embodiments, the intent classifier 114 operates independently of workflow model 110. Alternatively, the client computing device 102 transmits the query to the generative model 112, which forwards the query to the workflow model 110 to perform intent classification (e.g., by intent classifier 114).

At 204, the intent classifier 114 receives the input from client computing device 102 and generates an output indicative of an intent. As mentioned previously, the intent classifier 114 is configured to receive the input set forth by the user and produce an output indicative of an intent associated with the input. The intent is indicative of an objective related to the input, such as, for example, shopping. The intent may be further refined into a sub-intent. Output of the intent classifier may comprise multiple layered and/or combined intents. For example, an input of “what are the best tennis shoes made by X brand?” may be determined by the intent classifier has having a global shopping intent, while having a branding intent (e.g., “X brand”) and a category intent (“tennis shoes”). In certain embodiments, the intent classifier 114 may generate output indicative of an intent or sub-intent associated with an output of the generative model 112.

The workflow model 110 receives the output of the intent classifier 114 and obtains grounding data (e.g., from knowledge corpus 122) based upon the intent indicated by the output of the intent classifier 114. At 206, the workflow model 110 generates a prompt (e.g., by way of prompt generator 116) and provides the prompt to the generative model 112. At 208, responsive to receiving the prompt from workflow model 110, the generative model 112 generates an output based upon the prompt provided by workflow model 110. The output is transmitted to the workflow model 110 for further enhancement (as opposed to conventional generative model systems, which would transmit output directly back to the client computing device 102).

At 210, the workflow model 110 enhances the output. At the workflow model, the workflow model 110 can modify the output of the generative model with supplemental content, for example, content generated by the workflow model 110 and/or obtained from an intent-specific knowledge corpus 122 and/or supplemental content data store 124. The supplemental content applied to the output may comprise additional text, graphical elements, or the like. The supplemental content may be related to suggested responses to the output that will further refine previous user input. For example, the resultant output from the generative model 112 responsive to the input of “what are some birthday gifts for my wife” may comprise a list of gifts that the generative model compiled based on the prompt provided to the generative model. The workflow model 110 parses the output of the generative model 112 and obtains from one or more external data stores information related to each of the gifts identified by the generative model in the output. The workflow model 110 then generates further supplemental content adding additional contextual information and insight into the additional information obtained from the data stores. In an example, insights generated by the workflow model 110 are indicative of a summarized review of a product associated with the output. In some embodiments, interaction with the supplemental content at the client computing device (e.g., when the output including the supplemental content is displayed at the client computing device) causes the workflow model 110 to generate a new or updated prompt. From the supplemental content, the workflow model 110 may identify attributes associated with an object of the output and further identify which attributes are considered most important (e.g., according to the knowledge corpus 122). The supplemental content can be integrated into the output which is then transmitted to the client computing device 102 for presentation to the user.

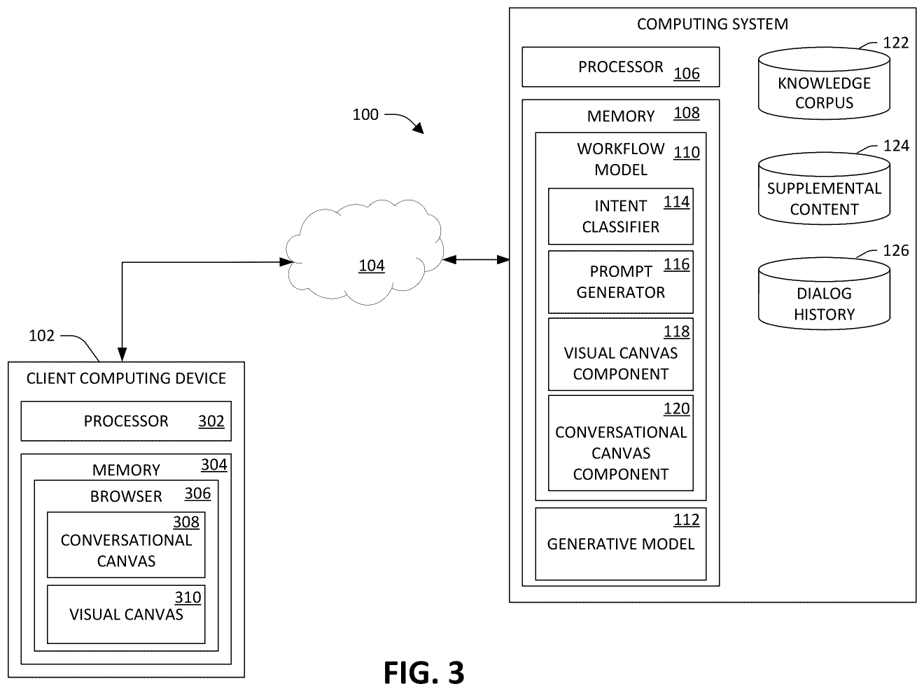

At 212, the enhanced output is transmitted back the client computing device 102. The communications diagram in FIG. 2 represents a high-level aspect of the communication between the client computing device 102, the workflow model 110, and the generative model 112. Further aspects and features will now be described with reference to FIG. 3.

With reference now to FIG. 3, another functional block diagram of the computing system 100 is presented. The computing system 100 is in communication with the client computing device 102, and the client computing device 102 includes a processor 302 and memory 304, where the memory 304 has a web browser 306 loaded therein. The web browser 306 has a conversational canvas 308 (e.g., generative model interface) incorporated therein, where the web browser 306 provides information to the workflow model 110 and/or generative model 112 by way of the conversational canvas 308. Similarly, the workflow model 110 and/or generative model 112 provides information to the web browser 306 by way of the conversational canvas 308. Aspects of the conversational canvas 308 may be generated or be caused to be generated by the conversational canvas component 120 of workflow model 110. For example, when enhanced output generated by workflow model 110 is transmitted for presentation to the user at client computing device 102, graphical and/or textual elements may be added to the output. These elements may be interactive, i.e., when activated by the user (e.g., by button click, etc.), data is sent from the client computing device 102 to the workflow model 110 to be included in subsequent prompt generation. User interaction or selection of an element may cause the workflow model 110 to cause data corresponding to the element to be displayed at the visual canvas 310. In certain embodiments, the data corresponding to the element to be displayed at the visual canvas 310 comprises, videos, articles, product reviews, social media interactions, etc.

The web browser 306 additionally comprises a visual canvas 310 incorporated therein, where the web browser 306 provides information to the visual canvas 310 by way of the conversational canvas 308. Similarly, the generative model 112 provides information to the web browser 306 by way of the conversational canvas 308. Aspects of the visual canvas 310 may be generated or be caused to be generated by the visual canvas component 118 of workflow model 110. The visual canvas component 118 may receive signals indicative of user interaction with elements displayed at the visual canvas 310 at the client computing device 102. Responsive to the signals, the visual canvas component 118 may cause data received from the visual canvas at the client computing device to be included by the workflow model 110 in a prompt. For example, if input is received from the client computing device 102 indicative of a certain user action with respect to a graphical element on the visual canvas (e.g., button click, expansion of a list of items, “tell me more” button, etc.) data based upon that interaction at the visual canvas can caused to be included in a prompt generated by the workflow model 110. Concurrently with the generation of an updated prompt based on the visual canvas signals, the workflow model 110 may cause updated visual data (e.g., based upon the user action, the updated prompt, etc.) to be rendered at the visual canvas 310.

Not all user action at the visual canvas will generate a signal that causes the data related to the signal to be added to a prompt by the workflow model 110. For instance, certain actions may be related to merely browsing content, and not amount to an intent from the user to update a prompt and generate new output by the generative model 112. These actions may cause a signal to be received by the visual canvas component, but only certain signals will trigger action by the workflow model 110. Absent receiving an instructive signal at the visual canvas component 118, the workflow model 110 will not include data from the visual canvas in a prompt. More specifically, the workflow model 110 may refrain from providing the certain information received from the visual canvas 310 to the generative model 112 (e.g., within a prompt generated by workflow model 110) until further user input is received (e.g., indicating that the user intends to interact with the generative model 112). This process enables the conversational canvas 108 and the visual canvas 310 to operate independently but synchronize upon user action that is an indication that the generative model 112 should be invoked.

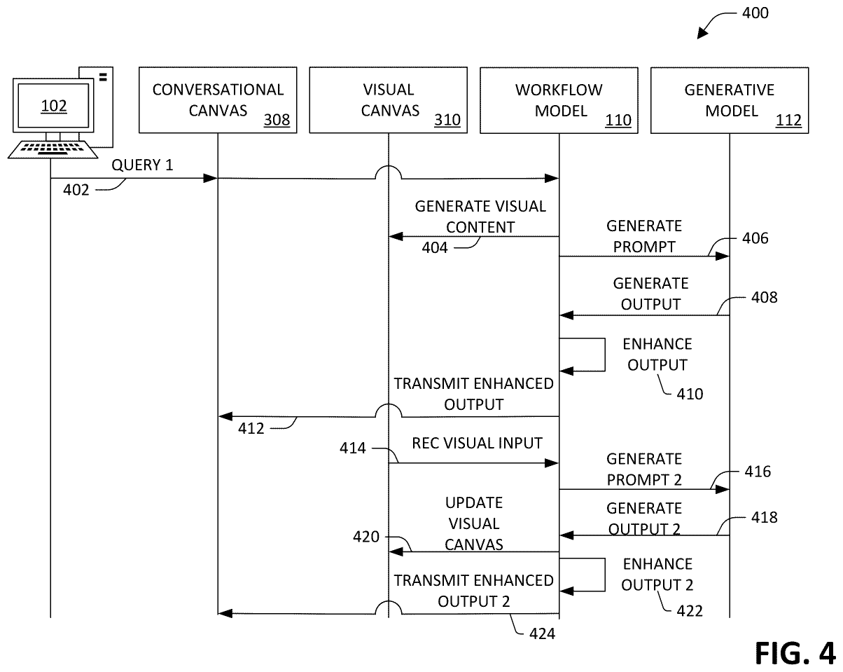

Referring to FIG. 4, a communications diagram 400 depicting communications between the client computing device 102, the conversational canvas 308, the visual canvas 310, the workflow model 110, and the generative model 112 in accordance with a first example is presented. At 402, a user query is provided as input into the conversational canvas 308. As described herein, there are several entry points by which a user may demonstrate an intent to interact with the exemplary systems as described herein. For example, within the context of a conventional search engine search, a suggested “pop-up”, “chat-box” or the like may appear within a browser or other graphical user interface operated at client computing device 102. Interaction with the element may trigger interaction with the workflow model 110 and generative model 112 as described herein. As another example, a user at computing device 102 may be currently interacting with an instance of a generative model, and upon recognition of a specific intent (e.g., shopping) the workflow model 110 may be triggered. The conversational canvas passes the input to the workflow model 110 which triggers operation of the workflow model.

At 404, the workflow model 110 generates visual content or causes visual content to be displayed at the visual canvas, where the content is related to the user query. In certain embodiments, the workflow model causes execution of a web service that renders the visual content relevant to the user query for presentation to the user at the client computing device (e.g., at the visual canvas 310). At 406, the workflow model 110 generates a prompt to provide to the generative model 112 based upon the user query. At 408, responsive to receiving the prompt from the workflow model 110, the generative model 112 generates an output based on the provided input and passes the output back to the workflow model 110. At 410, the workflow model 110 generates an enhanced output. For example, the workflow model 110 may generate enhanced output based upon the output received from the generative model 112 and supplemental content received from one or more data stores.

At 412, the enhanced output generated by the workflow model 110 is transmitted to the conversational canvas 308 for presentation to a user. At 414, the workflow model 110 receives visual input (e.g., signal) from the visual canvas 310. The visual input received causes information related to that input to the included into a second prompt generated by workflow model 110 at 416. In an example, a user clicks on a product which the workflow model 110 has caused to be displayed at the visual canvas 310 based upon the query. Responsive to receiving the signal from the visual canvas that a click action was taken, the workflow model 110 may query the knowledge corpus 122 and/or the supplemental content data store 124 and obtain information related to the product. As described previously, certain signals from the visual canvas will be ignored and not included in a prompt by the workflow model 310.

At 418, the generative model generates a second output responsive to the second prompt generated by the workflow model 110. The workflow model 110 then causes updated visual canvas information (e.g., additional information about the product obtained from the knowledge corpus 122 and/or the supplemental content data store 124) to be displayed at the visual canvas 310. The workflow model 110 enhances the second output at 422 and transmits the enhanced second output for display at the conversational canvas 308 at 424.

This process can repeat as the workflow model receives additional inputs from the user of the client computing device 102. For instance, the workflow model 110 may receive a second input query from the client computing device 102; upon receipt of such input, the workflow model can generate a third prompt based upon: 1) the query initially obtained by the workflow model 110 at 402; 2) the input obtained at 414; 3) the second prompt generated by the workflow model 110; 4) the enhanced output generated by the workflow model 110; or 5) the second enhanced output generated by the workflow model 110.

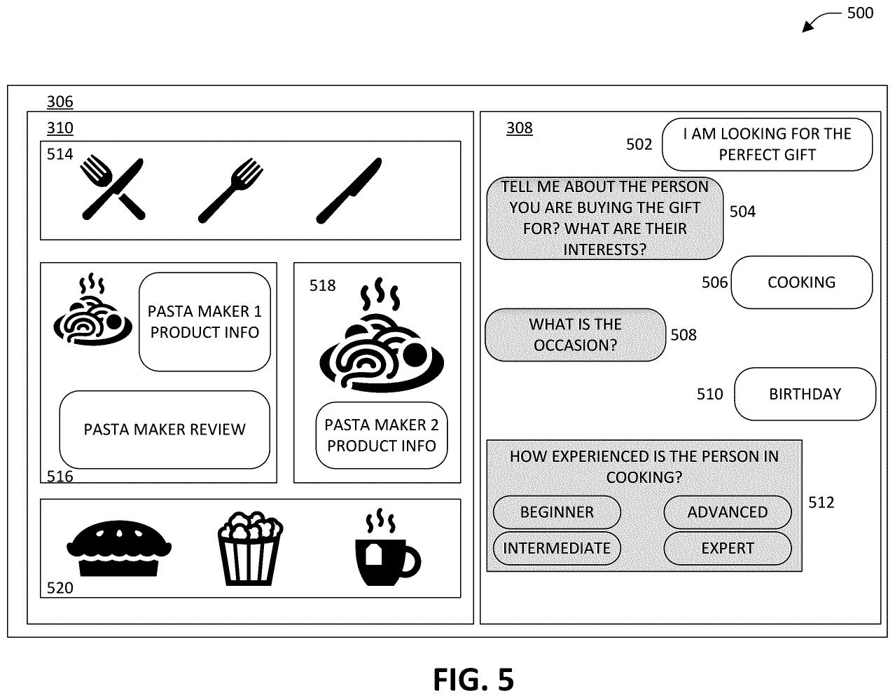

Further operation of the computing system 100 is described with reference to FIG. 5, which illustrates an exemplary GUI 500. The GUI 500 comprises browser 306 with a conversational canvas 308 and a visual canvas 310 executing on a client computing device 102. An input query set forth by a user is illustrated at 502. In the example illustrated in FIG. 5, query 502 is “I AM LOOKING FOR THE PERFECT GIFT.” The query 502 is transmitted from the client computing device 102 to the intent classifier 114. The intent classifier 114 analyzes the query and generates an output indicative of an intent. In this example, an intent indicated by the intent classifier 114 could be a “shopping” intent, as the query is directed to finding an item to purchase and give as a gift.

The workflow model 110 analyzes the query 502 and generates a prompt to provide as input into generative model 112. Aspects of query 502 that the workflow model 110 may identify to include in the prompt grounding data could be related to shopping, gift gifting, etc., as they relate to the intent as indicated by the output of the intent classifier 114. The workflow model 110 may generate the prompt based on prior interactions with the user of the client computing device, for example, by obtaining usage history information from the dialog history data store 126. Responsive to the workflow model 110 providing the prompt to the generative model 112, the generative model 112 is caused to generate an output based upon the prompt. The workflow model 110 can identify supplemental content related to the output, for example, by way of a query to the knowledge corpus 122 and/or supplemental content data store 124. The workflow model 110 then generates an enhanced output based upon the output received from the generative model 112 and supplemental content. In certain embodiments, the workflow model 110 may pass an unaltered output of the generative model 112 for display at the conversational canvas 308. In some embodiments, the enhanced output includes a query in response to the input in order to narrow the initial query.

The enhanced output generated by workflow model 110 is transmitted to be displayed at the conversational canvas 308 as output 504. The output 504 is responsive to the query 502 and, in this example, asks clarifying questions, “TELL ME ABOUT THE PERSON YOU ARE BUYING THE GIFT FOR? WHAT ARE THEIR INTERESTS?” In response, the conversational canvas 308 receives input from the user in query 506 which is responsive to output 504 and provides the responsive input, “COOKING.” When the workflow model 110 receives query 506, the workflow model 110 may identify visual content related to the query that can be rendered at the visual canvas 310. Upon identification of relevant visual content, the workflow model 110 causes visual content related to “cooking” and the original query to be rendered at the visual canvas 310. According to the present example, such visual content would for example, include popular cooking related gifts. Exemplary visual content is illustrated on the visual canvas 310 as visual elements 514-520.

The query 506 is then transmitted to the workflow model 110 similar to the prior query 502, which results in the enhanced output 508 to be transmitted from the workflow model. The output 508 is instructive to further reduce the query by soliciting information regarding the occasion. A responsive query 510 is received which indicates that the occasion for the cooking gift to be purchased is for a birthday. Each iteration of the query and output within the conversational canvas provides further information for the workflow model 110 to include in a successive prompt to provide to the generative model 112. As illustrated in the visual canvas 310, the visual elements 516 and 518 are illustrative of elements that have been interacted with by the user of the client computing device, as shown by their expanded view displaying additional information about the product (in this example, pasta makers). Accordingly, upon indication that an element displayed within the visual canvas was interacted with, a signal may be transmitted to the workflow model 110. The workflow model may then include elements of the selected element (in this example, pasta makers) within the next prompt generated by the workflow model 110. The output 512 is illustrative of an inclusion of the visual canvas interaction. As illustrated, output 512 comprises another follow up query, however, this time user-selectable suggestions are rendered alongside the output text, which can guide user input to more accurately inform the next user input. In this example, the user selection of the pasta maker visual elements in the visual canvas 310 causes the workflow model 110 to include the pasta maker elements (or information related thereto) in the last prompt. In response, the output 512 explicitly seeks clarification regarding cooking experience. The workflow model 110 may determine that the selected pasta maker is correlated with high cooking experience (e.g., through analysis of reviews, buying guides, etc. obtained from the knowledge corpus 122) and may be too difficult for beginning cooks, and therefore clarification of an experience level may assist in refining the query.

The process illustrated in FIG. 5 represents an improvement over both conventional search engines as well as conventional generative models for intent based queries, such as shopping. Utilizing the technologies described herein, the GUI 500 presents information to the user that was previously unable to be presented—a conversational interface that provides the user with tailored information beyond what is available via conventional generative models. Furthermore, the rendering of visual content at a visual canvas adjacent to the conversational canvas creates a robust user experience beyond conventional search or conventional generative model experiences. In addition, the workflow model provides information to the user that is relatively up to date (as compared to conventional generative models alone) and is tailored to the specific intent of the user.

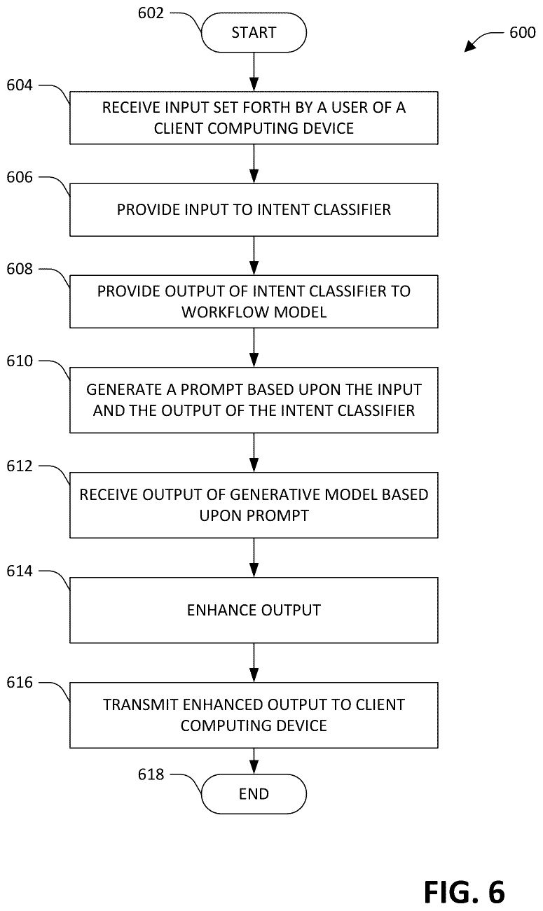

FIG. 6 illustrates a methodology relating to generation of enhanced output of a generative model. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 6, a methodology 600 for generating an enhanced output received from a generative model is illustrated. The methodology 600 starts at 602, and comprises, receiving input set forth by a user of a client computing device at 604. At 606 the input is provided to an intent classifier. The intent classifier is configured to produce an output indicative of a user intent based upon the input. At 608, the output of the intent classifier is provided to a workflow model. At 610, at the workflow model, a prompt is generated based upon the output of the intent classifier and the input. When the prompt is provided to the generative model, the generative model generates an output based on the prompt. At 612, output of the generative model is received, wherein the output is based upon the prompt. At 614, the output is enhanced by the workflow model, as described herein. At 616, the workflow model transmits the enhanced output to the client computing device. The methodology 600 completes at 618.

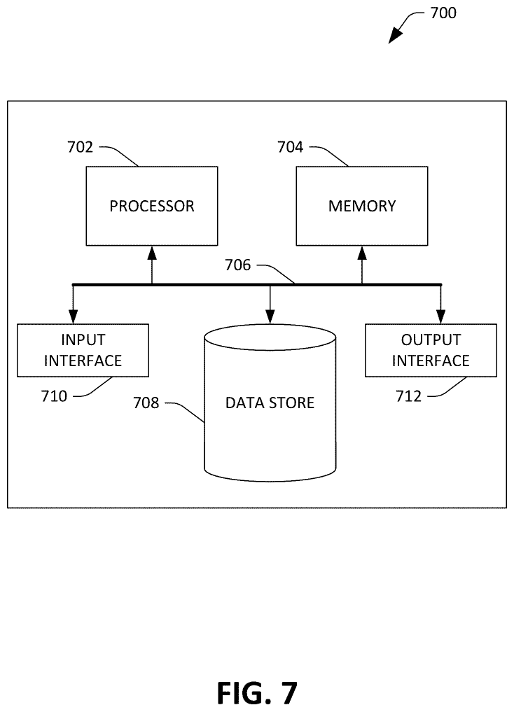

Referring now to FIG. 7, a high-level illustration of an exemplary computing device 700 that can be used in accordance with the systems and methodologies disclosed herein is illustrated. For instance, the computing device 700 may be used in a system that is configured to generate output by a workflow model responsive to an output of a GLM. The computing device 700 includes at least one processor 702 that executes instructions that are stored in a memory 704. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store prompts, images, videos, etc.

The computing device 700 additionally includes a data store 708 that is accessible by the processor 702 by way of the system bus 706. The data store 708 may include executable instructions, instant answers, a web index, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 700 may be a distributed system. Thus, for instance, several devices may be in communication by way of a network connection and may collectively perform tasks described as being performed by the computing device 700.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Described herein are various features pertaining to integration of a computer-implemented workflow model and a generative model in accordance with at least the following examples.
(A1) In an aspect, a method described herein comprises receiving an input set forth by a user of a client computing device that is in network communication with the computing system. The method further comprises providing the input to an intent classifier, wherein the intent classifier produces an output indicative of a user intent based upon the input. The method additionally comprises generating a prompt based upon the input and the user intent. The method further comprises providing the prompt as input into a generative model, wherein providing the prompt to the generative model causes the generative model to generate an output based upon the prompt, wherein the output is responsive to the input. The method additionally comprises identifying supplemental content related to the output. The method further comprises generating an enhanced output based upon the output and the supplemental content. The method additionally comprises transmitting the enhanced output to the client computing device for presentation to the user.
(A2) In some embodiments of the method of (A1), the enhanced output is presented to the user of the client computing device at a conversational canvas associated with the client computing device.
(A3) In some embodiments of the method of at least one of (A1)-(A2), the method further comprises identifying visual content based upon the input and the user intent and causing the visual content to be output to the client computing device for presentation to the user at a visual canvas associated with the client computing device.
(A4) In some embodiments of the method of at least one of (A1)-(A3), the conversational canvas and the visual canvas are caused to be displayed at a graphical user interface (GUI), wherein the conversational canvas and visual canvas are concurrently displayed within the same GUI.
(A5) In some embodiments of the method of at least one of (A1)-(A4), the method additionally comprises receiving a second input set forth by the user of the client computing device, wherein the second input is indicative of an interaction with a visual element within a visual canvas associated with the client computing device.
(A6) In some embodiments of the method of at least one of (A1)-(A5), the method further comprises maintaining synchronization between the conversational canvas and the visual canvas based upon a subsequent input.
(A7) In some embodiments of the method of at least one of (A1)-(A6), the method additionally comprises generating a second prompt based upon the second input indicative of an interaction with a visual element within the visual canvas. The method further comprises identifying a second visual content based upon second input and causing the second visual content to be output to the client computing device for presentation to the user at the visual canvas.
(A8) In some embodiments of the method of at least one of (A1)-(A7), the supplemental content identified by the workflow model comprises visual content to be presented at a visual canvas associated with the client computing device.
(A9) In some embodiments of the method of at least one of (A1)-(A8), the method additionally comprises generating a second prompt based upon a second input set forth by the user of the client computing device, wherein the second input is indicative of an interaction with a visual element within a visual canvas. The method additionally comprises identifying visual content based upon the second input. The method further comprises causing the visual content to be output to the client computing device for presentation to the user at the visual canvas.
(A10) In some embodiments of the method of at least one of (A1)-(A9), the method further comprises receiving a second input set forth by the user of the client computing device. The method additionally comprises providing the second input to the intent classifier, wherein the intent classifier produces a second output, wherein the second output is indicative of a user sub-intent based upon the second input and the output of the intent classifier.
(A11) In some embodiments of the method of at least one of (A1)-(A10), the method additionally comprises generating a second prompt based upon the input and a sub-intent. The method further comprises providing the second prompt as input into the generative model, wherein providing the prompt to the generative model causes the generative model to generate a second output based upon the second prompt, wherein the second output is responsive to the second input. The method further comprises identifying supplemental content related to the second output and generating an enhanced second output based upon the second output and the supplemental content. The methods additionally comprises transmitting the enhanced second output to the client computing device for presentation to the user.
(A12) In some embodiments of the method of at least one of (A1)-(A11), the supplemental content is identified from a shopping corpus of data, wherein the shopping corpus of data comprises information pertaining to products related to the input.
(A13) In some embodiments of the method of at least one of (A1)-(A12), the identifying supplemental content related to the output and generating the enhanced output based upon the output and the supplemental content are performed by a second generative model.
(B1) In another aspect, a method comprises receiving an input set forth by a user of a client computing device, wherein the input is indicative of a user interaction with a conversational canvas associated with the client computing device. The method further comprises identifying visual content based upon the input. The method additionally comprises causing the visual content to be output to the client computing device for presentation to the user at a visual canvas associated with the computing device. The method further comprises generating a prompt based upon the input. The method additionally comprises providing the prompt as input into a generative model, wherein providing the prompt to the generative model causes the generative model to generate an output based upon the prompt, wherein the output is responsive to the input. The method additionally comprises identifying supplemental content related to the output. The method further comprises generating an enhanced output based upon the output and the supplemental content. The method additionally comprises transmitting the enhanced output to the client computing device for presentation to the user at the conversational canvas.
(B2) In some of the embodiments of the method of (B1), the method further comprises receiving a second input set forth by the user of the client computing device, wherein the second input is indicative of an interaction with a visual element of visual content being displayed within the visual canvas.
(B3) In some of the embodiments of the method of at least one of (B1)-(B2), the method further comprises generating a second prompt based upon the second input. The method further comprises identifying a second visual content based upon the second input. The method additionally comprises causing the second visual content to be output to the client computing device for presentation to the user at the visual canvas.
(B4) In some of the embodiments of the method of at least one of (B1)-(B3), the method further comprises generating, by the generative model, a second output based upon a second prompt.
(B5) In some of the embodiments of the method of at least one of (B1)-(B4), the enhanced output comprises one or more insights, wherein the one or more insights are indicative of a summarized review of a product associated with the output.
(B6) In some of the embodiments of the method of at least one of (B1)-(B5), the identifying supplemental content related to the output and generating the enhanced output based upon the output and the supplemental content are performed by a second generative model.
(C1) In another aspect, a computing system includes a processor and memory, where the memory stores instructions that, when executed by the processor, cause the processor to perform at least one of the methods disclosed herein (e.g., any of the methods of (A1)-(A13) or (B1)-(B6)).
(D1) In yet another aspect, a computer-readable storage medium includes instructions that, when executed by a processor, cause the processor to perform at least one of the methods disclosed herein (e.g., any of the methods of (A1)-(A13) or (B1)-(B6)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computing system comprising:
a processor; and
memory storing instructions that, when executed by the processor, cause the processor to perform acts comprising:
receiving an input set forth by a user of a client computing device that is in network communication with the computing system;
providing the input to an intent classifier, wherein the intent classifier produces an output indicative of a user intent based upon the input;
generating a prompt based upon the input and the user intent;
providing the prompt as input into a generative model, wherein providing the prompt to the generative model causes the generative model to generate an output based upon the prompt, wherein the output is responsive to the input;
identifying supplemental content related to the output;
generating an enhanced output based upon the output and the supplemental content; and
transmitting the enhanced output to the client computing device for presentation to the user.

2. The computing system of claim 1, wherein the enhanced output is presented to the user of the client computing device at a conversational canvas associated with the client computing device.

3. The computing system of claim 2, further comprising:
identifying visual content based upon the input and the user intent; and
causing the visual content to be output to the client computing device for presentation to the user at a visual canvas associated with the client computing device.

4. The computing system of claim 3, wherein the conversational canvas and the visual canvas are caused to be displayed at a graphical user interface (GUI), wherein the conversational canvas and visual canvas are concurrently displayed within the same GUI.

5. The computing system of claim 1, further comprising:
receiving a second input set forth by the user of the client computing device, wherein the second input is indicative of an interaction with a visual element within a visual canvas associated with the client computing device.

6. The computing system of claim 5, further comprising:
maintaining synchronization between the conversational canvas and the visual canvas based upon the second input.

7. The computing system of claim 5, further comprising:
generating a second prompt based upon the second input indicative of an interaction with a visual element within the visual canvas;
identifying a second visual content based upon second input;
causing the second visual content to be output to the client computing device for presentation to the user at the visual canvas.

8. The computing system of claim 1, wherein the supplemental content identified by the workflow model comprises visual content to be presented at a visual canvas associated with the client computing device.

9. The computing system of claim 1, further comprising:
generating a second prompt based upon a second input set forth by the user of the client computing device, wherein the second input is indicative of an interaction with a visual element within a visual canvas;
identifying visual content based upon the second input;
causing the visual content to be output to the client computing device for presentation to the user at the visual canvas.

10. The computing system of claim 1, further comprising:
receiving a second input set forth by the user of the client computing device;
providing the second input to the intent classifier, wherein the intent classifier produces a second output, wherein the second output is indicative of a user sub-intent based upon the second input and the output of the intent classifier.

11. The computing system of claim 10, further comprising:
generating a second prompt based upon the input and the sub-intent;
providing the second prompt as input into the generative model, wherein providing the prompt to the generative model causes the generative model to generate a second output based upon the second prompt, wherein the second output is responsive to the second input;
identifying supplemental content related to the second output;
generating an enhanced second output based upon the second output and the supplemental content;
transmitting the enhanced second output to the client computing device for presentation to the user.

12. The computing system of claim 1, wherein the supplemental content is identified from a shopping corpus of data, wherein the shopping corpus of data comprises information pertaining to products related to the input.

13. The computing system of claim 1, wherein the identifying supplemental content related to the output and generating the enhanced output based upon the output and the supplemental content are performed by a second generative model.

14. A method, the method comprising:
receiving an input set forth by a user of a client computing device, wherein the input is indicative of a user interaction with a conversational canvas associated with the client computing device;
identifying visual content based upon the input;
causing the visual content to be output to the client computing device for presentation to the user at a visual canvas associated with the computing device;
generating a prompt based upon the input;
providing the prompt as input into a generative model, wherein providing the prompt to the generative model causes the generative model to generate an output based upon the prompt, wherein the output is responsive to the input;
identifying supplemental content related to the output;
generating an enhanced output based upon the output and the supplemental content; and
transmitting the enhanced output to the client computing device for presentation to the user at the conversational canvas.

15. The method of claim 14, further comprising:
receiving a second input set forth by the user of the client computing device, wherein the second input is indicative of an interaction with a visual element of visual content being displayed within the visual canvas.

16. The method of claim 15, further comprising:
generating a second prompt based upon the second input;
identifying a second visual content based upon the second input;
causing the second visual content to be output to the client computing device for presentation to the user at the visual canvas.

17. The method of claim 16, further comprising:
generating, by the generative model, a second output based upon the second prompt.

18. The method of claim 14, wherein the enhanced output comprises one or more insights, wherein the one or more insights are indicative of a summarized review of a product associated with the output.

19. The method of claim 14, wherein the identifying supplemental content related to the output and generating the enhanced output based upon the output and the supplemental content are performed by a second generative model.

20. A non-transitory computer-readable storage medium comprising instructions that, when executed by a processor, cause the processor to perform acts comprising:
receiving an input set forth by a user of a client computing device that is in network communication with the computing system;
providing the input to an intent classifier, wherein the intent classifier produces an output indicative of a user intent based upon the input;
generating a prompt based upon the input and the user intent;
providing the prompt as input into a generative model, wherein providing the prompt to the generative model causes the generative model to generate, an output based upon the prompt, wherein the output is responsive to the input;
identifying supplemental content related to the output;
generating an enhanced output based upon the output and the supplemental content; and transmitting the enhanced output to the client computing device for presentation to the user.
